(19) United States
(12) Patent Application Publication
(10) Pub. No.: US 2015/0199741 A1
(43) Pub. Date: Jul. 16, 2015

(54) PROTECTING CONSUMER SAFETY AND PRIVACY

(71) Applicant: FREQUENTZ, LLC, DEL MAR, CA (US)

(72) Inventor: Michael T. Lucas, Solona Beach, CA (US)

(21) Appl. No.: 14/155,929

(22) Filed: Jan. 15, 2014

(51) Int. Cl. G06Q 30/06

(52) U.S. Cl. CPC G06Q 30/0623

(57) ABSTRACT

In a computer-implemented method for product notification a mobile subscriber identity is transmitted to register the user for a product notification service without transmitting the name of the user. A product provider identifier is sent and a notification pertaining to products associated with the product provider identifier is received in accordance with the product notification service. This and other methods may be performed with a system including a processor, a memory and an application loaded on the memory. The application further includes a transmitter configured to send a mobile subscriber identity associated with a user from the mobile device to anonymously register the user for a notification service and to send an identifier of one or more providers of products received by the user and a messenger arranged to receive a notification.

### TECHNICAL FIELD

The present disclosure pertains to managing information regarding products and services.

### BACKGROUND

Social networks and providers of digital media frequently monitor user activity to mine market data without user awareness or consent. The number of promotional messages the typical consumer receives each day is intrusive and these messages frequently require the recipient to “unsubscribe” in order to prevent future messages from the same sender. Consumers are often unsure how they ended up on the mailing list.

These factors, among many others, have caused many consumers to be cautious with sharing personal data so that future unsolicited promotional material can be avoided. This has created challenges for product and service providers who require consumer data to facilitate targeted marketing. Additionally, the commonplace privacy-violating techniques do not determine with any certainty which products or services a user actually receives since there is no direct user testimony.

Manufacturers purchase digital media and exploit social networks spending billions of advertising dollars to build brand awareness or influence consumer purchases. However, since these advertising campaigns rarely engage with target consumers directly, advertising success is unreliable.

Retailers and other distributors typically do not permit a product provider direct engagement with consumers. Instead, consumer information is withheld for possible later sale back to the product provider. However, during events such as product recalls, important information regarding products and services must be expeditiously sent to consumer.

While some retailers do have loyalty or wholesale programs that include an alert notification, the notifications are dependent upon the retailer for ultimate delivery to consumers. Since relevant product or alert notifications are issued by the product provider these programs are not practical for efficient communication. Furthermore, consumers would need to participate in many loyalty or wholesale programs to be assured of receiving all relevant product or alert notifications. Even then, individual retailer programs would need to be individually monitored. The provider's reputation and brand are at stake during a product recall and the provider ultimately controls a corresponding cash incentive or consumer notice to reclaim the consumer's confidence. If the recall is not well-handled, administration costs, shipping costs, fixing, replacing and/or disposing costs, communication, public relations and advertisement costs, inventory costs, lost sales of the recalled products, government fines, legal expenses, lost future sales, reputation and brand image impact may be incurred by the provider.

### SUMMARY

In one aspect, the present disclosure provides for a computer-implemented method for product notification. The method involves, in response to a user request, transmitting a mobile subscriber identity to register the user for a product notification service without transmitting the name of the user, sending a product provider identifier and receiving a notification pertaining to products associated with the product provider identifier in accordance with the product notification service.

In another aspect, a computer program product for product notification is provided. The computer program product residing on a non-transitory computer-readable storage medium and comprising instructions which, when executed by a processor, cause a computer to: transmit a mobile subscriber identity to register a user for a product notification service without transmitting the name of the user; to send a product provider identifier; and to receive a product notification pertaining to products associated with the product provider identifier in accordance with the product notification service.

In yet another aspect, a system is having a processor, a memory and an application loaded on the memory. The application further includes a transmitter configured to send a mobile subscriber identity associated with a user from the mobile device to anonymously register the user for a notification service and to send an identifier of one or more providers of products received by the user and a messenger arranged to receive a notification pertaining to products associated with the identifier of the one or more providers.

### BRIEF DESCRIPTION OF THE DRAWINGS

The summary above, as well as the following detailed description of illustrative embodiments, is better understood when read in conjunction with the appended drawings. For the purpose of illustrating the present disclosure, example constructions of the disclosure are shown in the drawings. However, the present disclosure is not limited to specific methods and instrumentalities disclosed herein. Moreover, those having ordinary skill in the art will understand that the drawings are not to scale. Wherever possible, like elements have been indicated by identical numbers.

Embodiments of the present disclosure will now be described, by way of example only, with reference to the following diagrams wherein:

FIG. 1 illustrates an example schematic overview of a product notification network 2000, in accordance with one embodiment.

FIG. 2 illustrates an overview flow diagram of an example method for a product notification service, in accordance with one embodiment.

FIG. 3 illustrates a flow diagram of a first example method for product notification, in accordance with one embodiment.

FIG. 4 illustrates a flow diagram of a second example method for product notification, in accordance with one embodiment.

FIG. 5 illustrates a flow diagram of an example method for product authentication usable with a product notification service, in accordance with one embodiment.

FIG. 6 illustrates a block diagram of an example intelligence service, in accordance with one embodiment.

FIG. 7 illustrates a block diagram of a first example server notification system, in accordance with one embodiment.

FIG. 8 illustrates a block diagram of a second example server notification system, in accordance with one embodiment.

FIG. 9 illustrates a flow diagram of a first example mobile method for product notification, in accordance with one embodiment.

FIG. 10 illustrates a flow diagram of a second example mobile method for product notification, in accordance with one embodiment.

FIG. 11 illustrates a block diagram of an example client notification system, in accordance with one embodiment.

FIG. 12 illustrates a flow diagram of an example user experience with a mobile method for product notification, in accordance with one embodiment.

FIG. 13 illustrates an example user interface configured for use with a user product notification system to facilitate product selection.

FIG. 14 illustrates an example user interface configured for use with a user product notification system to facilitate product organization.

### DETAILED DESCRIPTION

The following detailed description illustrates embodiments of the present disclosure and manners by which they may be implemented. Although the best mode of carrying out the present disclosure has been disclosed, those skilled in the art will recognize that other embodiments for carrying out or practicing embodiments described in the present disclosure are also possible.

Embodiments of the present disclosure provide systems, computer-implemented methods as well as computer program products to invite a user to register, according to his or her preferences, for notifications about product updates, alerts, recalls, or other product information.

Embodiments of the present disclosure substantially eliminate, or at least partially address, problems in the prior art, providing users with one central repository of notification data rather than a number of individual retail systems.

According to disclosed systems and methods an anonymized user identifier, such as a mobile subscriber identity, is known only by the user and a server notification system, not the product provider. As such, users may experience an improved sense of consumer privacy. Because disclosed systems and methods can validate and/or certify user data based upon each unique anonymized user identifier, the provider does not need direct access to the user data.

Products for which the notification service may offer particular advantages include health products such as medications; home appliances such as smoke or carbon monoxide detectors, furnaces, water heaters or air conditioning units; home improvement articles such as electric saws, lawn mowers or generators; automotive vehicles including trucks, recreational personal watercraft or motorcycles; and Food & Beverage items such as Consumer Packaged Goods (CPG); and electronics like televisions, computers, printers and game consoles.

Market dynamics are changing as consumers have increasing control of engagement and, with the disclosed systems and methods, can now opt-in for connection to the original source of products they have received. Consumers are offered greater control over the protection of their health and their privacy while facilitating a more targeted engagement for product providers. This level of engagement with the consumers also enables an influential market advantage for providers.

Additional aspects, advantages, features and objects of the present disclosure will be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### Definitions

As used here, the terms “first”, “second”, and the like, do not denote any order, quantity, or importance, but rather are used to distinguish one element from another.

As used herein, the terms “a” and “an” do not denote a limitation of quantity, but rather denote the presence of at least one of the referenced item.

As used herein, the term “product” may encompass a service in addition to a physical object.

As used herein, the term “received” in the context of a product is to be considered as encompassing purchased and/or owned. As such, a product that is received by a consumer or other user may have been purchased by the user or is otherwise currently owned by the consumer. Thus, the term “received” may encompass a broader range of circumstances by which the user came into possession of or experienced the benefits of the product.

As used herein, the phrase “mobile subscriber identity” may encompass a digital, numerical, or computer program code used to identify a registered user of a mobile data processing device or system such as a mobile phone, a phablet or a tablet computer when the user is operating the mobile device or system over a communications network. A typical mobile subscriber identity is comprised of a mobile country code, a mobile network code and a mobile subscription identification number. In accordance with some telecommunications standards, “mobile subscriber identity” may be referred to as a “mobile subscriber identifier” or “international mobile subscriber identity.”

As used herein, the phrase “product provider” may encompass an entity that prepares a product or initiates delivery of a product or service to an end user. A product provider may be a manufacturer or similar entity not typically responsible for final presentation directly to an end user. However, in some product or service supply chains a manufacturer, distributor and retailer may be regarded as a single entity.

As used herein, the phrase “product notification service” encompasses a series of actions intended to notify a user such as a consumer regarding information about one or more products the consumer has received and offer a provider of the one or more products feedback information, marketing data, etc. from the notified user.

### System Overview

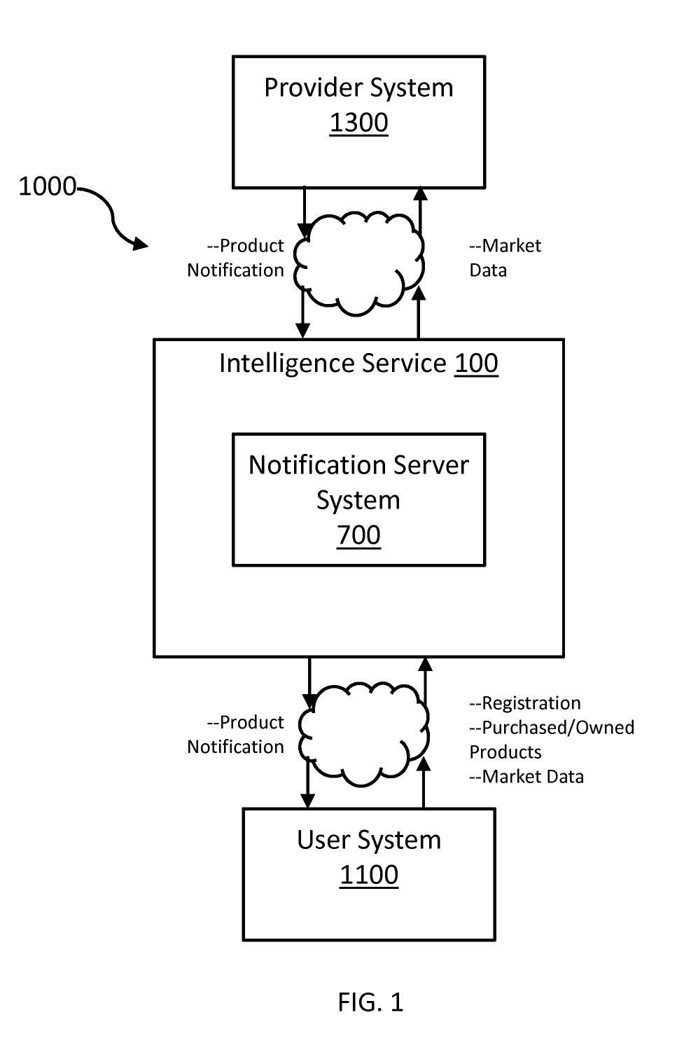

FIG. 1 is a schematic illustration of an example product notification network 2000, in accordance with one embodiment. Product notification network 2000 includes one or more data processing systems, depicted as client or user notification system 1100, intelligence service 100 and provider system 1300 in FIG. 1.

Examples of the data processing systems 100, 1100 and 1300 include, but are not limited to, smart telephones, Mobile Internet Devices (MIDs), tablet computers, Ultra-Mobile Personal Computers (UMPCs), phablet computers, Personal Digital Assistants (PDAs), web pads, Personal Computers (PCs), handheld PCs, laptop computers, desktop computers, Network-Attached Storage (NAS) devices, large-sized touch screens with embedded PCs, and interactive entertainment devices, such as game consoles, Television (TV) sets and Set-Top Boxes (STBs).

The data processing systems 100, 1100 and 1300 communicate through network 2000. Network 2000 may be implemented in various ways, depending on service requirements. In one example, network 2000 may be implemented by way of a spatially collocated arrangement of servers and databases. In another example, network 2000 may be implemented by way of a spatially distributed arrangement of server and database coupled mutually in communication. In yet another example, a server and database may be implemented through cloud computing services.

Network 2000 can be a collection of individual networks, interconnected with each other and functioning as a single large network. Such individual networks may be wired, wireless, or a combination thereof. Examples of such individual networks include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, and Worldwide Interoperability for Microwave Access (WiMAX) networks.

Network 2000 is suitable for implementing various systems for product notification. In order to implement a system for product notification, intelligence service 100 provides data services to user system 1100 and provider system 1300. In some embodiments, user system 1100 may access intelligence service 100 to download one or more software products associated with the product notification service. In one embodiment, user system 1100 is arranged in a manner so that its functionality is implemented partly in data processing system 1100 and partly within intelligence service 100. Similarly, in one embodiment, provider system 1300 is arranged so that its functionality is implemented partly in provider system 1300 and partly within intelligence service 100.

Provider system 1300 allows a provider to access, update and manage product notifications and associated content. Furthermore, system 1300 allows the provider to receive information about how many anonymized user identifiers have selected the provider or specific products as among those received by the user.

The product notification service can be offered free of cost or, alternatively, can be a service paid for by product providers or product users or consumers that has a subscription-based billing or a transaction-based billing, such as pay-per-use and pay-per-feature.

It should be noted that FIG. 1 is merely an example, which should not unduly limit the scope of the claims herein. It is to be understood that the specific designation for network 2000 is provided as an example and is not to be construed as limiting network 2000 to specific numbers, types, or arrangements of data processing systems, servers, databases and communication networks. A person skilled in the art will recognize many variations, alternatives, and modifications of embodiments of the present disclosure.

### Example Product Notification Processes

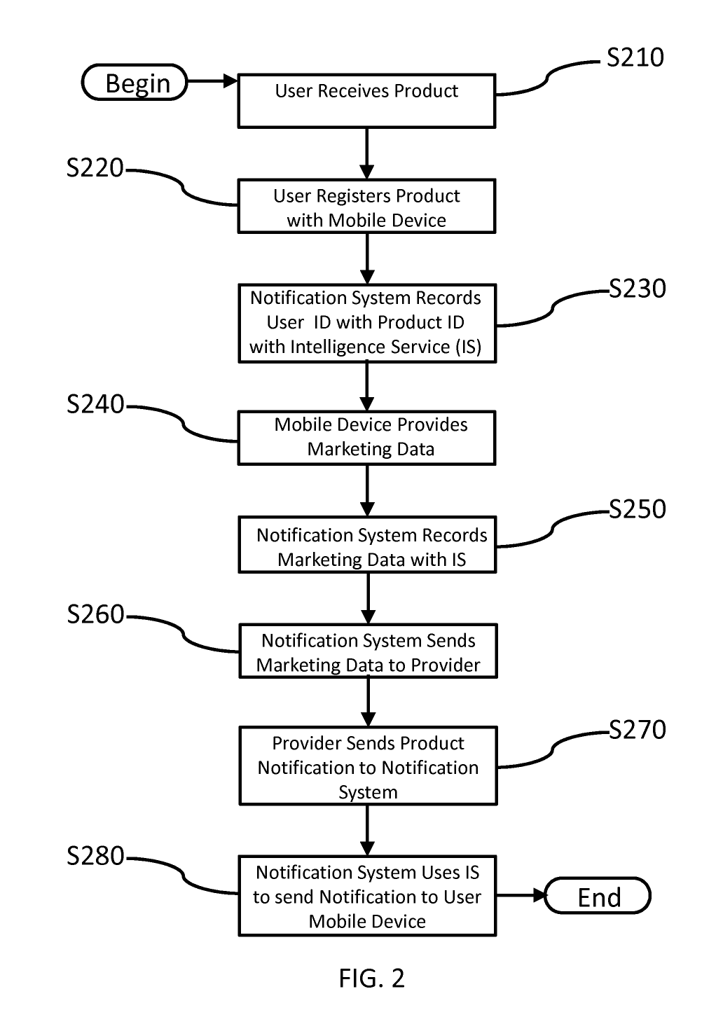

FIG. 2 is an illustration of steps of a method 200 for providing a product notification service in accordance with an embodiment of the present disclosure. The method is depicted as a collection of steps or actions in a logical flow diagram. Some steps or actions may be performed by one or more data processing devices or systems while others may be performed by one or more users without any data processing device or system.

As can be seen in FIG. 2, a user receives a product in a step S210. As described above, the user may purchase the product or may come into possession of the product by other means.

Having received the product, the user may desire to receive occasional notifications regarding the product. In a step S220, the user registers to receive notifications regarding the product. A preliminary step of downloading a product notification application may be necessary before registration or such an application may have been previously configured on the mobile device.

During registration, the user selects one or more products for which they would like to receive product notifications. In step S230, the selection is recorded as a product identifier by a product notification system in association with an anonymized user identifier of the user. The product identifier used may be any of a variety of digital, numerical, computer program or image codes including but not limited to Product IDs, Stock Keeping Units, Universal Product Codes, Price Look Up codes, Electronic Product Codes or Global Trade Item Number. In some instances, the user may simply select a product provider or brand in order to receive product notifications for any product provided by the provider.

It should be noted that it is neither necessary that a user need register for the notification service immediately after product receipt nor register a particular product immediately after receiving that product. In fact, a period of time may often have elapsed between the receipt of the product and the registration with the notification service.

In some embodiments, at various stages during the process depicted in FIG. 2, the notification system collects marketing data from registered users and forwards this marketing data to product providers. For example, marketing data such as product identifiers correlated as substitute products or complimentary products may be transmitted from the user mobile device in a step S240 and collected by the notification system S250 in association with the anonymized user identifier, the product identifier or both. Reports summarizing analyzed data may subsequently be prepared and forwarded to product providers in a step S260. In some embodiments, information regarding the identity of the user, including the anonymized user identifier is completely withheld from the product providers.

As another example, marketing data, such as the geographic location of the user, may be forwarded to a product provider at the time of user registration or at a later time. In some embodiments, location information may be collected occasionally to enable determination of a region of a user's residence, workplace or other relevant location. With this information a provider may facilitate penetration into a target region or target zip code and may influence purchases in the local area of their retailers

With marketing data derived from the products and services users have actually received and their actual user locations, media presentations available to the users through the notification service may be provided to include advertising media prepared uniquely for that user. A provider may choose to advertise within a media presentation, such as an electronic newspaper, electronic magazine or video content, that is known to be consumed by users who have received a given product or products. Media presentations may be offered free to the users and paid for by the providers hoping to reach those users.

A provider may choose a specific television program from an entertainment network for matching to a target audience with which the provider seeks to create brand awareness. An entire television show or movie may then be promoted by the provider at a cost per viewer that achieves an improved return on investment. When seeking product or brand visibility, providers do not need to exhaust resources on consumers who are already receiving their products.

Marketing data may provide consumer insights regarding price consciousness and brand sensitivity. With data analysis, marketing data may enable prediction of the tendency of a consumer to purchase a product as well as discovery of what influence will be necessary, based on prior historical information, to convert to a new brand.

As described in greater detail below, location information associated with the anonymized user identifier may also be used in comparisons with product chains-of-custody to perform a verification process to reduce or eliminate consumer use of counterfeit products or services.

In a step S270, when a product provider issues a product notification to the notification system, the system determines which, if any, anonymized user identifiers are associated with the subject product of the product notification. In accordance with a step S280, once matches have been made, the notification system sends the product notice to the mobile devices of any and all users having anonymized user identifiers matched to the product notification through the product identifier.

The steps S210 to S280 are only illustrative and other alternatives can also be provided where one or more steps are added, one or more steps are removed, or one or more steps are provided in a different sequence without departing from the scope of the claims herein.

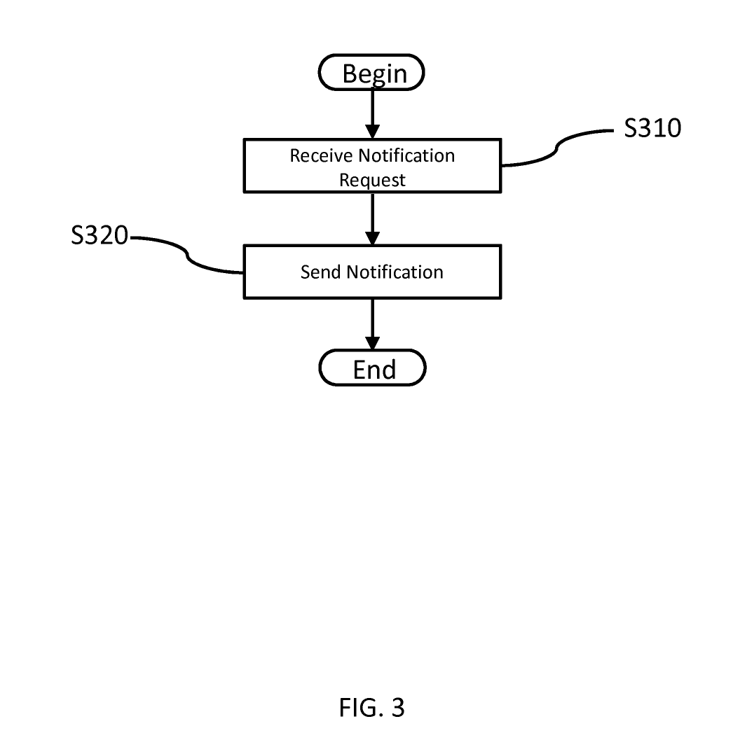

FIG. 3 is an illustration of steps of a computer-implemented method 300 for product notification, in accordance with an embodiment of the present disclosure. The method is depicted as a collection of steps or actions in a logical flow diagram, which represents a sequence of steps or actions that may be implemented in hardware, software, or a combination thereof.

As can be seen in FIG. 3, a product notification request is received from an anonymous product user identified by an anonymized user identifier in a step S310. In a step S320, the anonymized user identifier is employed to send a product notification to the anonymous product user in accordance with the product notification request. Sending of the product notification to the user may include transmitting the product notification to a user device associated with the anonymized user identifier. As an example, the product notification may be sent to a user mobile device such as a user tablet computer or mobile phone.

Any of a variety of types of product notifications including varying forms of content may be sent to the user and may elicit a variety of responses upon receipt. For example, a product notification may include a rebate, an incentive, a discount or a digital coupon or may include an alert regarding a travel hazard or product recall. In some embodiments, product notifications may remind users of products or activities that should be avoided based upon one or more of the products indicated as having been received by the user. For example, if a user has verified they have received a particular medication, one or more product notifications may include information pertaining to dangerous drug interactions.

Steps S310 and S320 are only illustrative and other alternatives can also be provided where one or more steps are added, or one or more steps are provided in a different sequence without departing from the scope of the claims herein.

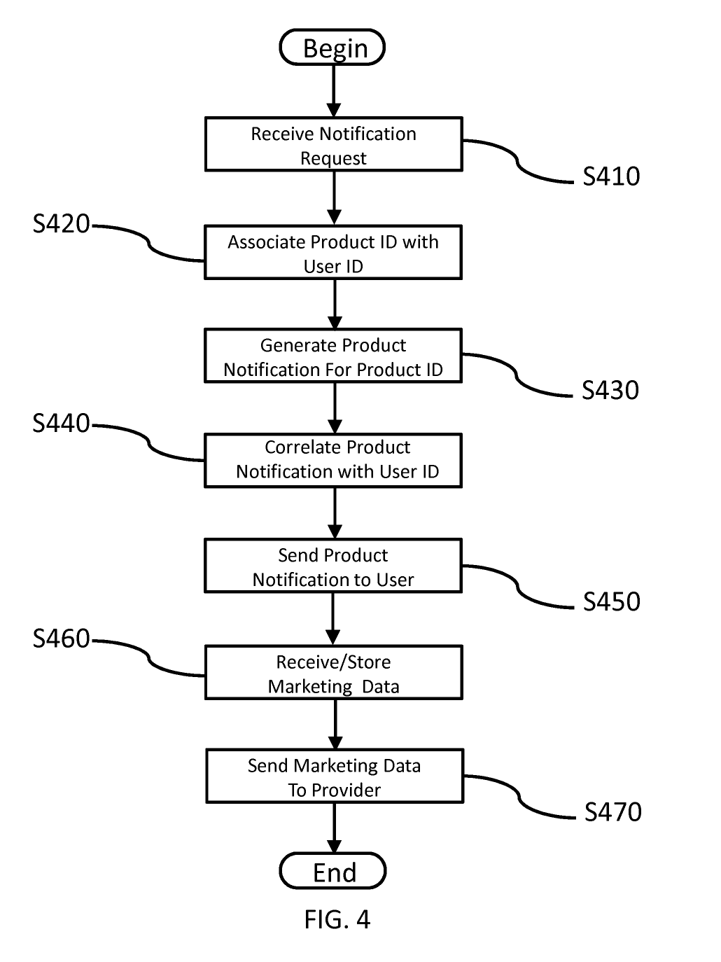

Referring to FIG. 4 and a method 400, in a more sophisticated embodiment, after receiving a product notification request from an anonymous product user in a step S410, an anonymous user identifier such as a mobile subscriber identity is associated with a product identifier according to a step S430 to facilitate future delivery of a product notification regarding a product identified by the product identifier. Typically, the product identifier will identify a product received by the user, however, the user need not necessarily have received the product to receive a product notification. When a product notification is received from a product provider, using the product identifier, the product notification is matched with or otherwise related to the anonymous user identifier in a step S440. With the identifiers related, the product notification is sent to the user in accordance with a step S450.

As described in greater detail below with respect to user method 1200, a registered anonymous user may be provided with a suggestion to invite to one or more additional users to register for product notifications. In some examples, invited users may be correlated with the anonymized user identifier of the inviting user before, during or after the invitation. For example, a user may select to invite additional users from a contacts list stored within a device associated with the anonymized user identifier.

In a step S460, marketing data associated with the anonymized user identifier is received by the notification system and stored. It should be noted that marketing data collection may begin during or immediately after receipt of a notification request. Additionally, marketing data may collected prior to or subsequent to sending of a product notification and may include location information associated with the anonymized user identifier. The “reviewed” status of a product notification may also be collected as a component of marketing data. Upon collection, marketing data may be immediately forwarded to a product provider associated with the product notification or may be held for sending at a later time according to a step S470.

The steps S410 to S470 are only illustrative and other alternatives can also be provided where one or more steps are added, one or more steps are removed, or one or more steps are provided in a different sequence without departing from the scope of the claims herein.

### Example Method for Product Authentication

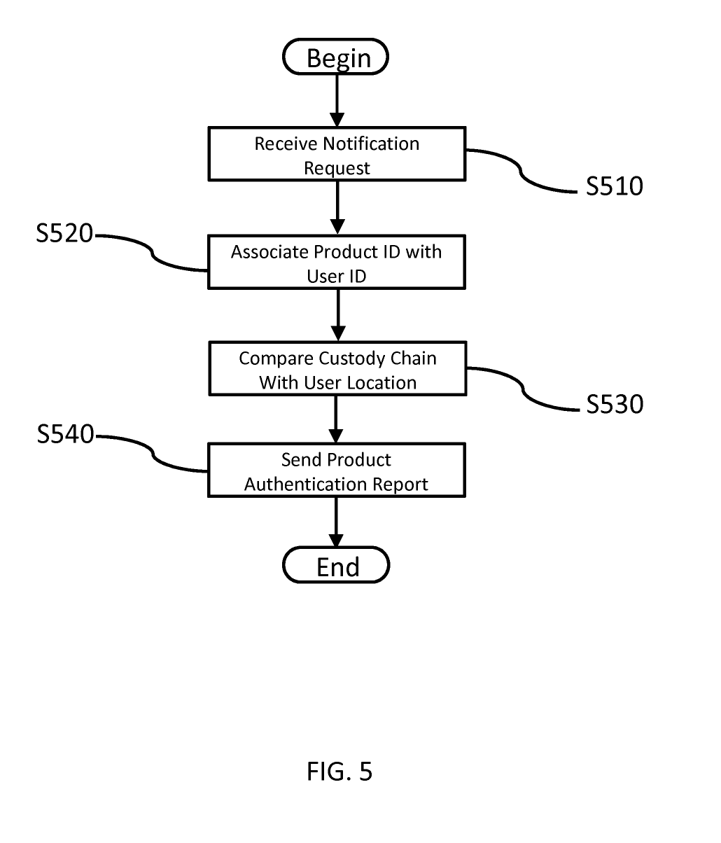

FIG. 5 illustrates a flow diagram of an example method 500 for product authentication usable with a product notification service including methods 300 and 400, in accordance with one embodiment. A notification request is received during a registration procedure as in either of steps S410 and S510. Once the notification request has been received and the anonymized user identifier has been associated with a product identifier as in either of steps S420 and S520, the product identifier may be authenticated, if desired. A last location in a chain of custody of the product identifier is compared with a location associated with the anonymized user identifier in a step S530. If user location and product location cannot be reconciled, the product may be counterfeit or may have been diverted without provider knowledge. An authentication report indicating whether or not the product identifier and the associated product can be verified may be sent to the user, to the product provider, or both.

The steps S510 to S540 are only illustrative and other alternatives can also be provided where one or more steps are added, one or more steps are removed, or one or more steps are provided in a different sequence without departing from the scope of the claims herein.

Embodiments of the present disclosure provide a computer program product that includes a non-transitory or non-transient computer-readable storage medium storing computer-executable code for providing product notification to users. The code, when executed, is configured to perform the steps S410 to S470 and steps S510 to S540 of methods 400 and 500. As steps of the disclosed methods may be provided in different sequences, so the computer-executable code may be configured to provide a service having a different sequence of actions from those illustrated in FIGS. 4 & 5. In some embodiments, a computer program product may be executed to cause a computing device to perform the steps S310 to S320 of method 300 as described in conjunction with FIG. 3.

A computer program product for notifying product users resides on a non-transitory computer-readable storage medium and comprises instructions which, when executed by a processor, cause one or more computers of intelligence service 100 to receive a product notification request from an anonymous product user identified by an anonymized user identifier such as a mobile subscriber identity. In response to one or more actions by the user, the instructions cause one or more computers to associate one or more product identifiers with the anonymized user identifier.

Furthermore, the instructions cause one or more computers to relate an provider product notification incoming from a provider with the product identifier and correlate the product notification with the user identifier. Then, according to the instructions, the anonymized user identifier is employed to send a product notification to the anonymous product user in accordance with the product notification request. For example, the product notification may be sent by the one or more computers to a mobile data processing device or other system associated with the anonymized user identifier.

When executed by a processor, the instructions further cause the one or more computers to associate the anonymized user identifier with a product identifier and compare a last location in a chain of custody of the product identifier with a location associated with the anonymized user identifier in order to authenticate the product identifier.

In some embodiments, the computer program product includes instructions that cause the one or more computers to solicit for receipt of product notification requests from one or more additional users correlated with the anonymized user identifier. For example, a user may send invitations to one or more friends or family members to suggest they also register to receive product notifications. As with the inviting user, registration by the friends or family will be accomplished anonymously with anonymized user identifiers. In still other embodiments, the user may be able to set up a “family” or “friends” account or a “friends and family” account which with or without input from the other persons may be configured to deliver product notifications to any member of the respective “family”, “friends” or “friends and family” account.

The computer program product may further include instructions that cause the one or more computers to store marketing data associated with the anonymized user identifier. The marketing data may include location information, the “reviewed” status of a product notification or a correlation between different products associated with the anonymized user identifier.

After storing the marketing data, the instructions cause the one or more computers to send the marketing data to a product provider associated either with a sent product notification or with a product identifier associated with the user.

The product notification sent by the one or more computers according to the instructions of the computer program product may include a rebate, an incentive, a discount, or a coupon or an alert regarding a product recall or a travel hazard.

### Intelligence Service

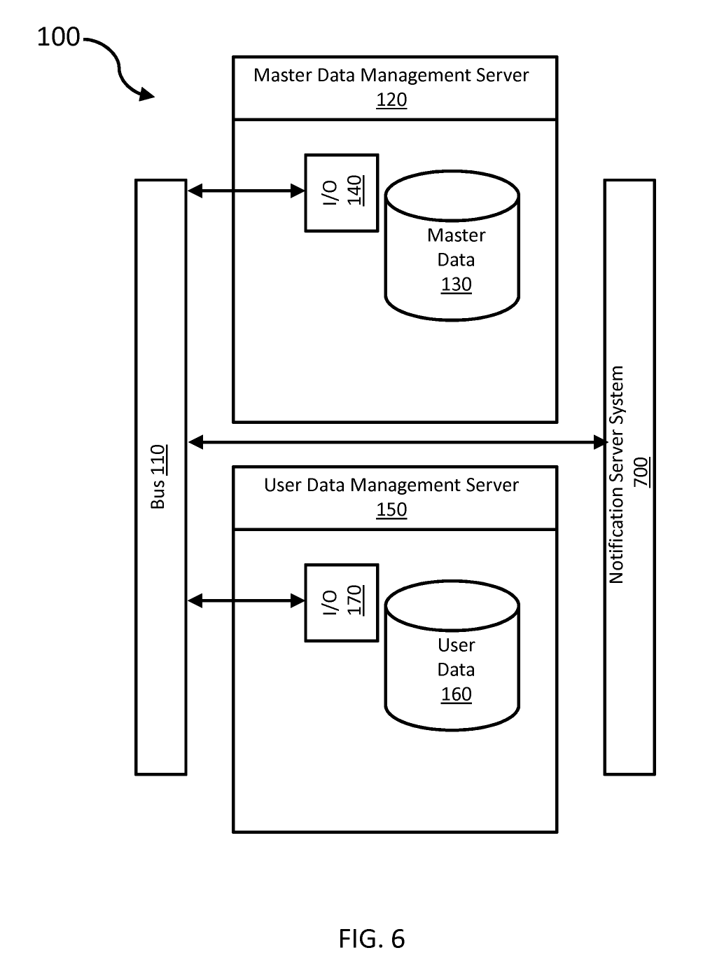

FIG. 6 is a schematic illustration of various components of an intelligence service 100, in accordance with an embodiment of the present disclosure. Intelligence service 100 may include, but is not limited to including, a master data management server 120, master data storage 130, Input/Output (I/O) devices 140, a user data management server 150, user data storage 160 and Input/Output (I/O) devices 170. Bus 110 operatively couples various components including master data management server 120, master data storage 130, Input/Output (I/O) devices 150, user data management server 150, user data storage 160 and Input/Output (I/O) devices 170 and may further couple notification server system 700 thereto.

The master data storage 130 and user data storage 160 may include non-removable memory, removable memory, or a combination thereof. The non-removable memory, for example, includes Random-Access Memory (RAM), Read-Only Memory (ROM), flash memory, or a hard drive. The removable memory, for example, includes flash memory cards, memory sticks, or smart cards. Master data storage 130 and user data storage 160 may be local to master data management server 120 and user data management server 150, remote therefrom or distributed throughout a communications network cloud. Various forms of security may be provided to prevent unauthorized access to data held in master data storage 130 and user data storage 160.

Master data storage 130 is a single source data repository giving product providers the ability to access master data originally describing applicable technical information, marketing information, other information, product images and product identifiers. In some embodiments, providers access data by synching through master data applications. Furthermore, applicable dates of purchase and any safety related information may be available to assist a user who may be considering purchasing a provider product from a third party or second-hand provider.

User data storage 160 includes a data profile of each user including an anonymized user identifier, provider identifiers, product identifiers, location information, “message reviewed” confirmations and a variety of marketing data.

### Example Notification Server Systems

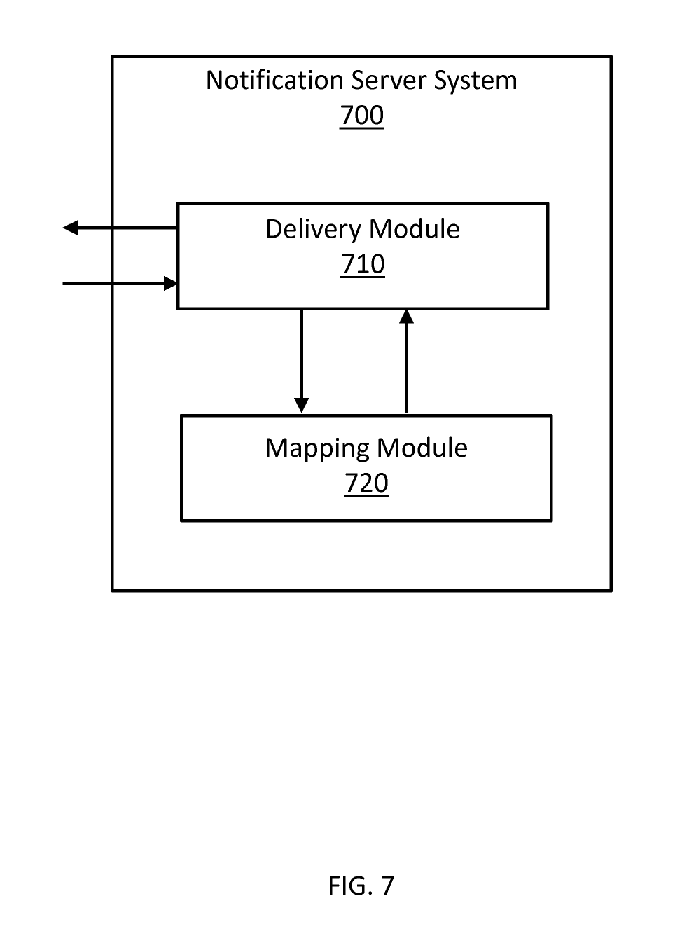

FIG. 7 illustrates a block diagram of a simplified notification server system 700 configured for notifying product users. System 700 includes a mapping module 720 and a delivery module 710. Mapping module 720 is arranged to associate a product notification request with an anonymous product user identified by an anonymized user identifier. Delivery module 710 is configured to send a product notification to the anonymous product user in accordance with the product notification request. System 700 is configured to send product notifications including but not limited to rebates, incentives, discounts, digital coupons or alerts regarding a product recall or travel hazard. Some product notifications may include combinations of these.

Referring to FIG. 7, in one embodiment, mapping module 720 and delivery module 710 are both components of a notification server system 700 provided as a supplement to an intelligence service 100 (FIGS. 1 & 6). In other embodiments, one or both of mapping module 720 and delivery module 710 are components internal to intelligence service 100 (not illustrated).

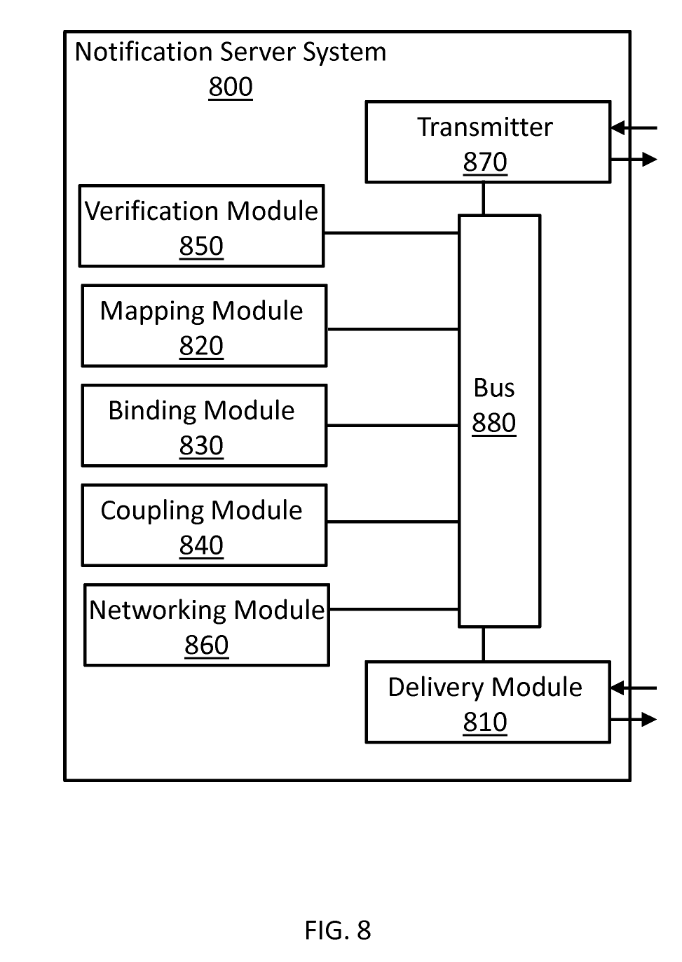

FIG. 8 illustrates a more developed notification server system 800. A mapping module 820 is arranged to associate a product notification request with an anonymous product user identified by an anonymized user identifier and to associate a product identifier of a product received by the anonymous user with the anonymized user identifier. A delivery module 810 is configured to send a product notification to the anonymous product user. In some configurations, the anonymized user identifier is a mobile subscriber identity and delivery module 810 sends the product notification to a mobile device associated with this mobile subscriber identity. Delivery module 810 may also be configured to receive, during anonymous user registration, the product notification request and the product identifier referenced thereby.

A binding module 830 is configured to relate a product notification with the product identifier and a coupling module 840 is formulated to correlate the product notification with the user identifier through use of the product identifier contained in the product notification request.

Notification server system 800 further includes a verification module 850 arranged to authenticate a product identifier associated with a user by mapping module 820. Authentication by verification module 850, as described in detail with reference to FIG. 5, involves comparing the last location in a product identifier chain of custody with a location associated with the anonymized user identifier.

System 800 may further comprise a contacts module or networking module 860 configured to solicit for receipt of product notification requests from one or more additional users correlated with the anonymized user identifier. It is noted that, in some embodiments, networking module 860 or equivalent will be provided directly on user system 1100 in order to convey additional control and privacy to the user. In such embodiments, networking module 860 may be eliminated from system 800.

One or more of the mapping module 820, the binding module 830 or the coupling module 840 are arranged to store, at an internal data storage or a separate data storage such as at master data storage 130 or user data storage 160, marketing data associated with the anonymized user identifier.

Marketing data may include location information associated with the anonymized user identifier, or a label reflecting whether or not the product notification has been reviewed by the anonymous user. As such, the label reflects the “reviewed” status of the product notification.

System 800 further comprises a transmitter 870 configured to send the marketing data to a product provider associated with the product notification and to receive product updates for packaging within a product notification.

As with notification server system 700, notification server system 800 may be provided as a supplement to an intelligence service 100 or portions thereof may reside as components of intelligence service 100.

### Example Client-Side Product Notification Methods

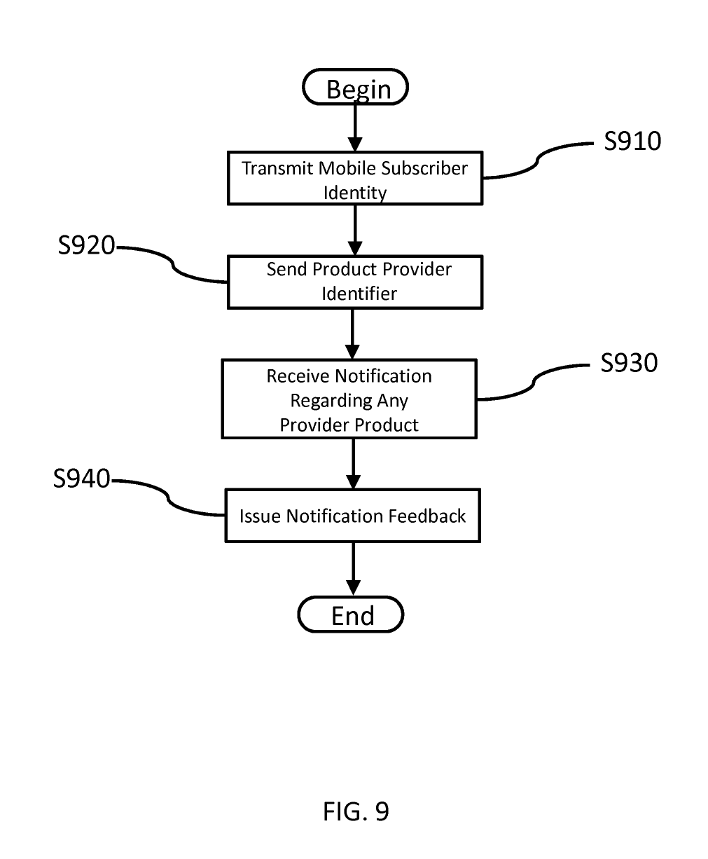

FIG. 9 illustrates steps of a first embodiment of a computer-implemented method for product notification 900 performed on a client system or user side system. The method is depicted as a collection of steps or actions in a logical flow diagram, which represents a sequence of steps or actions that may be implemented in hardware, software, or a combination thereof.

The computer-implemented method for product notification includes transmitting a mobile subscriber identity to register a user for a product notification service in a step S910. During registration, the name of the user is not transmitted. With the user registered, the user data processing device, in accordance with a step S920 sends a product provider identifier, supplier serial number or manufacturer's number corresponding to a provider selection made by the user. Once the product provider identifier is associated with the mobile subscriber identity, any notification pertaining to products associated with the product provider identifier will be received in accordance with the product notification service in a step S930.

According to a step S940, feedback from the user regarding the product notification may be issued from the user device or system for analysis in combination with feedback from other users. In one example of notification feedback, the feedback may be issued when the user engages with the product notification to confirm the user has reviewed the product notification, i.e., that a product recall notice was opened or a rebate or incentive was used. This feedback may form a part of or may be analyzed to provide marketing data for a product provider identified by the product provider identifier.

The steps S910 to S940 are only illustrative and other alternatives can also be provided where one or more steps are added, one or more steps are removed, or one or more steps are provided in a different sequence without departing from the scope of the claims herein.

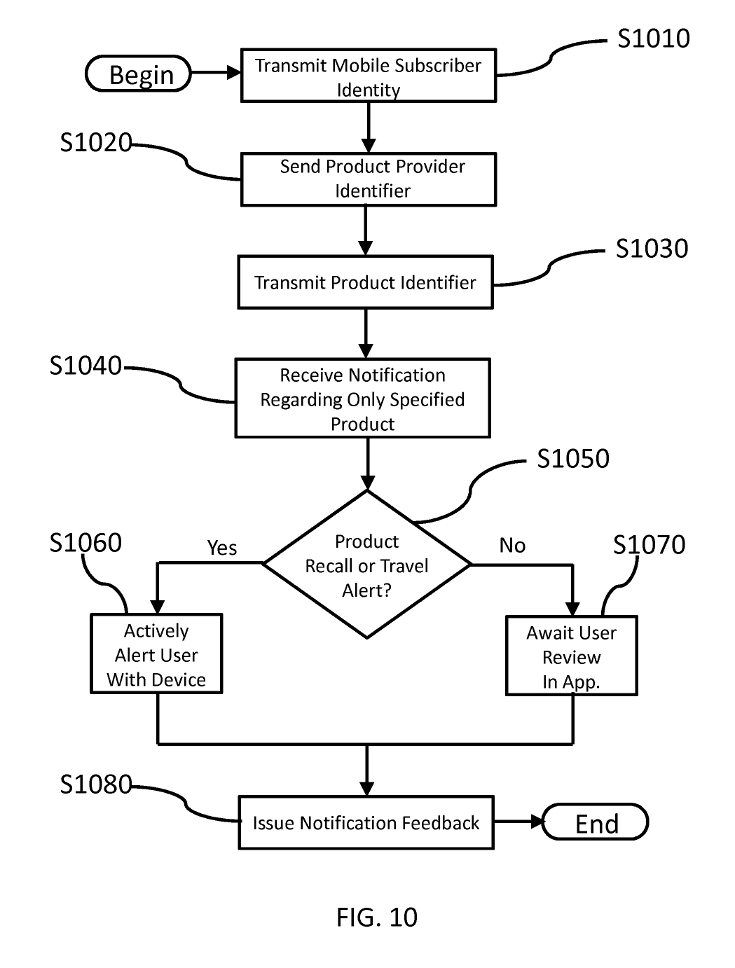

In some embodiments, in addition to sending a product provider identifier, the method may include the step of transmitting a product identifier as well. FIG. 10 is an illustration of steps of another embodiment of a computer-implemented method for product notification 1000 performed on a user system, in accordance with an embodiment of the present disclosure. The method is depicted as a collection of steps or actions in a logical flow diagram, which represents a sequence of steps or actions that may be implemented in hardware, software, or a combination thereof.

The computer-implemented method for product notification includes transmitting a mobile subscriber identity to register a user for a product notification service in a step S1010. During registration, the name of the user is not transmitted. With the user registered, the user mobile device, in accordance with a step S1020 sends a product provider identifier, supplier serial number or manufacturer's number corresponding to a provider selection made by the user with, for example, a menu or other user interface.

In a step S1030, a product identifier may be transmitted in addition to the product provider identifier sent in step S1020. For example, a user may be invited to select, one or more products associated with the established product provider identifier.

In some embodiments, the user may be permitted to select products directly, without the need for prior selection of a product provider. In these embodiments, step S1020 may be eliminated or may take place subsequent to step S1030 or simultaneous therewith. Once the product identifier is associated with the mobile subscriber identity, any notification pertaining to products associated with the mobile subscriber identity will be received in accordance with the product notification service in a step S1040.

After the product notification is received, it is established as one of a rebate, an incentive, a discount or a digital coupon or a travel or recall notice according to a step S1050. A travel notice may include a message describing potentially hazardous conditions that were present on a mode of transportation associated with the mobile subscriber identity. For example, like products, trips may also be associated with a mobile subscriber according to user selections. If a fellow passenger of the user is found to potentially be harboring a contagious disease, a travel alert associated with the trip may be presented to the user.

If the received product notification includes a travel notice, the product notification system actively alerts the user about a travel hazard in a step S1060 without requiring further input from the user.

Similarly, if the received product notification includes a product recall, the notification system actively alerts the user about a product recall in a step S1060 without requiring further input from the user.

It should be noted that some methods may include alerts other than travel and recall alerts. Systems may be configured to issue alerts during any of a variety of circumstances that may impact the user.

In one embodiment, product notification icons presented by a product notification messenger are highlighted, labeled or otherwise tagged according to their alert level, importance or criticality. For example, a product notification icon pertaining to a travel alert or product recall may be tagged in red whereas a product notification pertaining only to a rebate or incentive may be tagged in green.

According to a step S1080, feedback from the user regarding the product notification may be issued from the user device or system for analysis either alone or in combination with feedback from other users. As one type of notification feedback, to confirm the user has received a product notification, the mobile device may issue feedback when the user engages with the product notification. For example, feedback may be issued indicating that a travel notice was opened or that a rebate or incentive was used.

The steps S1010 to S1080 are only illustrative and other alternatives can also be provided where one or more steps are added, one or more steps are removed, or one or more steps are provided in a different sequence without departing from the scope of the claims herein.

### Example User Product Notification Device

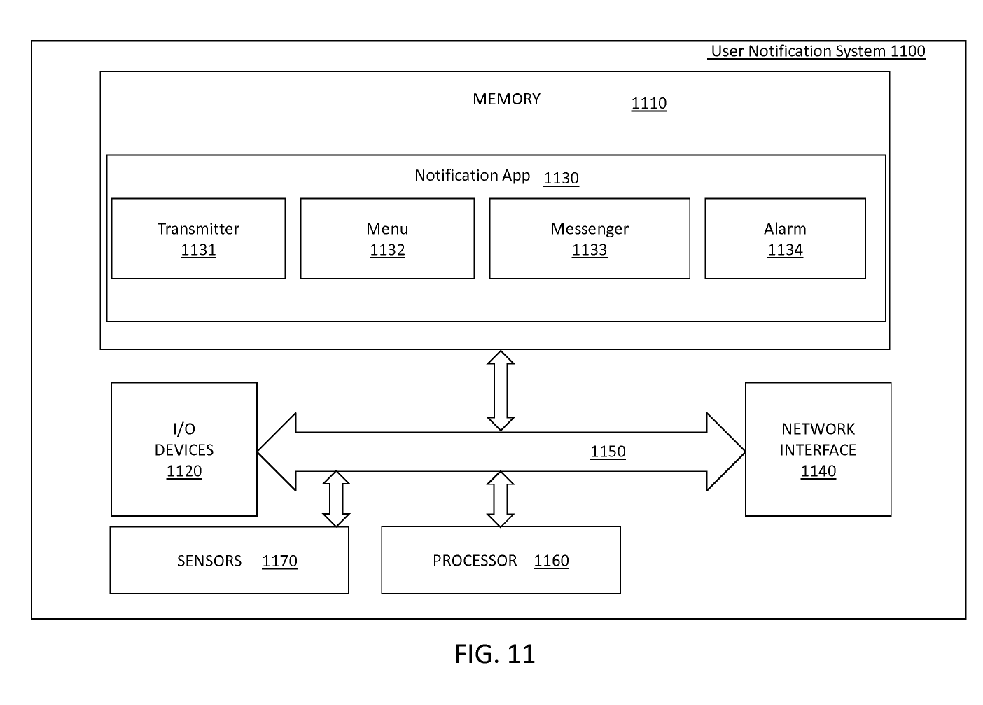

FIG. 11 is a schematic illustration of various components of a user product notification device or system 1100, in accordance with an embodiment of the present disclosure. User system 1100 may include, but is not limited to including, a memory 1110, a processor 1160, Input/Output (I/O) devices 1120, a network interface 1140, a configuration of sensors 1170, and a system bus 1150 that operatively couples various components among these. The I/O devices 1120 may include a display screen for presenting graphical images to a user of system 1100.

User product notification system 1100 also includes a power source for supplying electrical power to its various components. The power source may, for example, include a rechargeable battery.

Memory 1110 optionally includes non-removable memory, removable memory, or a combination thereof. The non-removable memory, for example, includes Random-Access Memory (RAM), Read-Only Memory (ROM), flash memory, or a hard drive. The removable memory, for example, includes flash memory cards, memory sticks, or smart cards.

The data memory 1110 stores a notification application 1130, comprising a transmitter 1131, a menu or similar user interface 1132, a messenger 1233, and an alarm 1134.

Transmitter 1131 is configured to send a mobile subscriber identity from system 1100 to anonymously register the user for a notification service, to send an identifier of one or more providers of products received by the user and/or to send an identifier of one or more products received by the user.

Menu 1132 is arranged to enable selection of one or more products received by the user and/or one or more providers of products received by the user.

In some examples, execution of notification app 1130 on processor 1160 may result in generating and rendering a graphical user interface in the form of menu 1132 on a display screen. In addition to enabling selection of products or product providers, menu 1132 is configured to generally facilitate user interactions with the product notification system. In some examples, the display screen may be a touch-sensitive display screen that is operable to receive tactile inputs from the user. These tactile inputs may, for example, include clicking, tapping, pointing, moving, pressing and/or swiping with a finger or a touch-sensitive object like a pen.

Messenger 1133 is arranged to receive a notification pertaining to products associated with the identifier of the one or more providers. Upon receiving a product notification, messenger 1133 may be arranged to invite the user to view a rebate, an incentive, a discount or a digital coupon or to view a message associated with a travel hazard or a product recall. Furthermore, messenger 1133 may be configured to issue a “message reviewed” confirmation when the user engages with a notification.

Alarm 1134 is configured to actively alert the user about a product recall or a travel hazard without requiring direct user engagement with the application. For example, application 1130 and alarm 1134 may be configured to cooperate with one or more hardware components of system 1100 such as I/O devices 1120 so that system 1100 sounds an audible alarm even while the user is not in contact with system 1100. In another example, while the user is interacting with system 1100 and while notification application 1130 is otherwise inactive, alarm 1134 may cause a visual alert to appear on a display thereby notifying the user to the hazardous circumstance.

Transmitter 1131, menu 1132, messenger 1133 and alarm 1134 may, for example, be parts of a software product associated with the product notification service provided, in part, by notification app 1130.

Application 1130 may further include an output configured to present a representation of the location of the user, which representation includes a depiction of a planet earth globe surrounded by an iris.

I/O devices 1120 may include a mouse or a joystick that is operable to receive inputs corresponding to clicking, pointing, and/or moving a pointer object on the graphical user interface. I/O devices 1120 may also include a keyboard that is operable to receive inputs corresponding to pushing certain buttons on the keyboard. Additionally, I/O devices 1120 may also include a microphone for receiving an audio input from the user, and a speaker for providing an audio output to the user.

Sensors 1170 may include one or more of: an accelerometer, a magnetometer, a pressure sensor, a temperature sensor, a gyroscopic sensor, a Global Positioning System (GPS) sensor, or a timer. Sensors 1170 may be used to measure and collect data related to surroundings of the user. In some examples, notification app 1130 may be interfaced with the sensors 1170. When executed on processor 1160 the software product is configured to resolve and integrate the outputs of the sensors 1170 into useful information about at least one of user location or product details. Sensors 1170 may include a camera or other imaging device arranged to capture visual information about a product the user has received or is considering obtaining. For example, a camera may be used to recognize a product or read a product label to record a product identifier associated with the product. Thus, the product may be confirmed as authentic, the user may be provided with product information, or both.

Furthermore, the network interface 1140 allows processor 1160 to upload information such as “message reviewed” status issued by messenger 1133 to a server, for example, through a notification network 2000. Additionally, network interface 1140 may allow client notification system 1100 to access a server to update notification app 1133 and/or download one or more new software products associated with a product notification service.

Moreover, the network interface 1140 optionally allows client product notification system 1100 to communicate with other client notification systems, for example, through a communication network.

Client notification system 1100 is optionally implemented by way of at least one of: a mobile phone, a smart telephone, an MID, a tablet computer, a UMPC, a phablet computer, a PDA, a web pad, a PC, a handheld PC, a laptop computer, a desktop computer, an NAS device, a large-sized touch screen with an embedded PC, and an interactive entertainment device, such as a game console, a TV set and an STB.

FIG. 11 is merely an example of a user product notification device, and should not unduly limit the scope of the claims herein. It is to be understood that the specific designation for client notification system 1100 is provided as an example and is not to be construed as limiting system 1100 to specific numbers, types, or arrangements of modules and/or components of system 1100. A person skilled in the art will recognize many variations, alternatives, and modifications of embodiments of the present disclosure.

Embodiments of notification app 1130 provide a computer program product that includes a non-transitory or non-transient computer-readable storage medium storing computer-executable code for a product notification service. The code, when executed, is configured to perform the steps S910 to S940 of the method 900, the steps S1010 to S1080 of the method 1000 or combinations of these. As steps of the disclosed methods may be provided in different sequences, so the computer-executable code may be configured to provide a service having a different sequence of actions from those illustrated in FIGS. 9 & 10. In some examples, the code may be downloaded from a software application store, for example, from an “App store”, to a data processing unit.

A computer readable program product including notification app 1130 comprises instructions which, when executed by a processor, cause a computer to transmit a mobile subscriber identity to register a user for a product notification service without transmitting the name of the user, to send a product provider identifier and to receive a product notification pertaining to products associated with the product provider identifier in accordance with the product notification service.

In some embodiments, after the instructions cause the computer to transmit the product provider identifier, the instructions further cause the computer to transmit a product identifier in association with the user identifier. In these embodiments, product notifications received may be limited to those notifications pertaining to products for which product identifiers have been transmitted from the user's mobile device.

Product notifications received by the computer according to instructions comprising the program product may include an invitation to view a rebate, an incentive, a discount, a digital coupon or a travel or recall alert.

When the received product notification includes travel hazard or product recall information, the instructions further cause the computer to actively alert the user about the travel hazard or product recall without requiring input from the user. As described above, initiation of these alerts does not require direct engagement or interaction by the user.

When the user engages with the sent product notification or a message accompanying the notification, processor 1160 may execute instructions causing the computer to issue a “notification reviewed” confirmation since confirming receipt by the user may be important to the product provider. For example, the product provider may be released from some level of liability if the user has reviewed a product recall notification but does not properly dispose of the recalled product and becomes ill or sustains an injury as a result. In some embodiments, the date and time of user review are included in the issued confirmation. In further embodiments, an automated voice telephone call may be placed to the user as an additional prompt to review an important notification regarding a product he or she has received.

In some embodiments, the instructions further cause the one or more computers to present a representation of the location of the user that, as described above, includes a depiction of a planet earth globe surrounded by an iris.

### Example User Experience During Product Notification

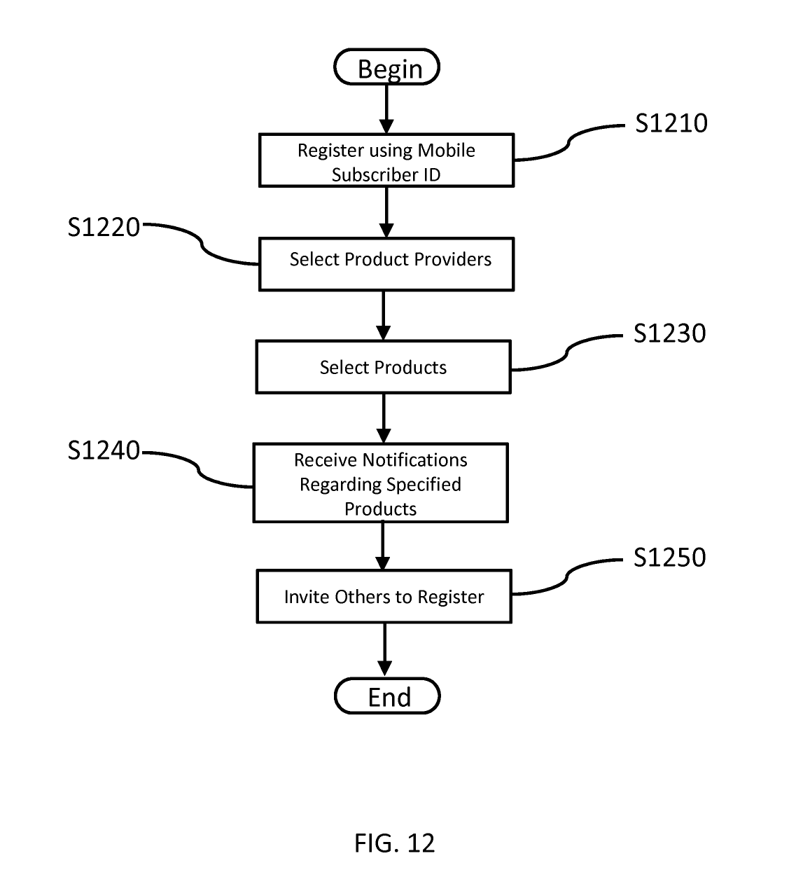

FIG. 12 illustrates a flow diagram of an example user experience 1200 during a method for product notification. Some steps or actions may be performed by one or more data processing devices or systems while others may be performed by one or more users without any data processing device or system.

In a step S1210, a consumer or other user wishing to receive product notifications uses his or her processing system 1100 to register his or her mobile subscriber identity with server notification system 700. Registration may commence as part of configuring a client product notification application on the processing system 1100 or may be initiated subsequent to the configuration of the application.

During registration or subsequent thereto, the user may be presented with a representation of his or her geographic location. For example, the user may be presented with a display showing a planet earth globe surrounded by an iris. The planet earth globe may be first presented in a spinning state, which slows to an orientation enabling visualization of the particular location of the user.

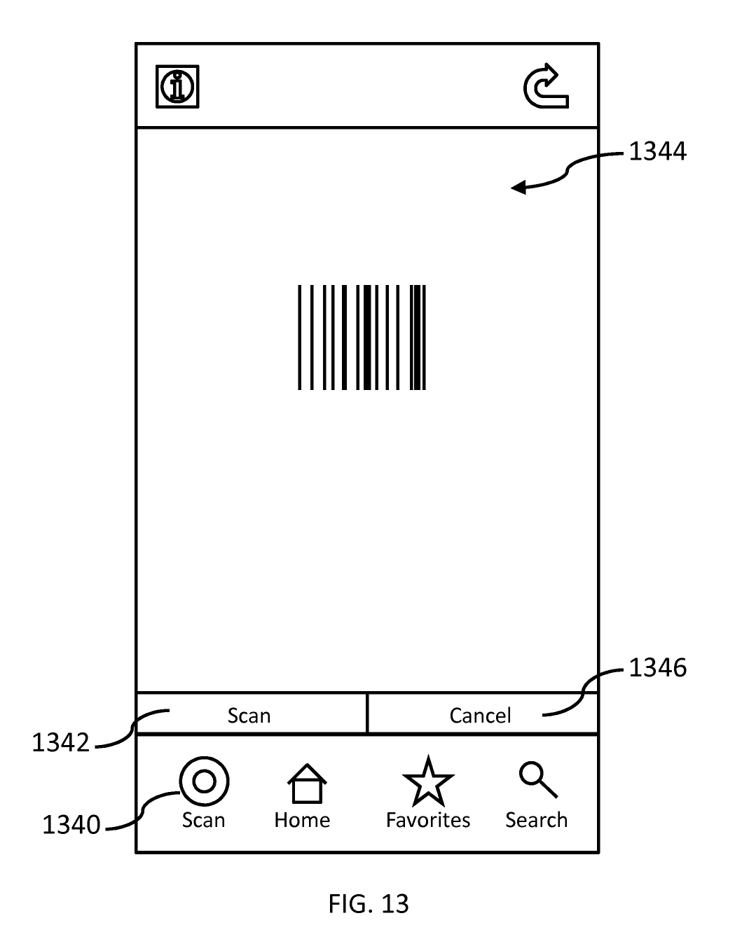

In a step S1220, the user selects product providers whose products the user has received. For example, a display of the user's system 1100 may present a number of provider icons and invite the user to select the appropriate provider icons. In some embodiments, the user is offered a deeper level of selection in a step S1230 with an invitation to select product icons of those products the user has received. In embodiments employing sensors 1170 such as a camera or other imaging device arranged to capture visual information about a product, the user may scan a portion of the product to make a selection. For example, the user may scan a universal product code (FIG. 13). After selecting “scan” icon 1340, the user may be presented display including a capture window 1344 and “scan” button 1342 and “cancel” button 1346.

With selections made, system 1100 transmits, to notification server system 700, product identifiers or product provider identifiers, which correspond with the selected product icons or product provider icons, respectively. After server notification system 700 has associated product identifiers with the mobile subscriber identity, future product notifications will be received at the user system 1100 in accordance with a step S1240.

In a step S1250, the user may invite others to register for the notification service. For example, the user may select one or more contacts from a contacts list recorded in system 1100 so that those contacts receive a message such as an email message, an SMS message or a voicemail message encouraging them to also register. It should be noted that step S1250, in particular, may be initiated at any of a variety of times during the method referred to by FIG. 11. For example, step S1250 may be applied directly after the user registers for the product notification service in step S1210.

At various stages of use, the user may be able to access user preferences to enable controlling any of a variety of settings of user system 1000. For example, the user may choose from what window of time he or she would like to receive product notifications so that notifications issued before he or she began receiving the benefits of the product notification service may be received retroactively.

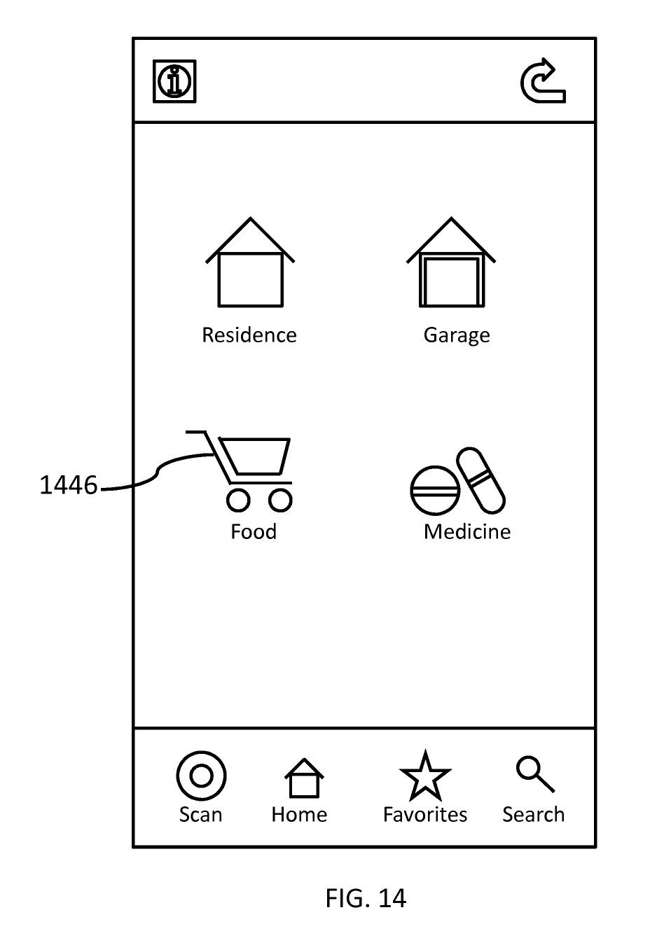

FIG. 14 illustrates an example user interface configured for use with a user product notification system. A number of computer icons may represent or designate a variety of product classes into which a user may organize received products for which he or she wishes to receive product notifications. For example, food products the user has received are associated with icon 1446 arranged to resemble a grocery cart. A system such as 1000 may store identifiers of received food products in memory 1110 according to classification of icon 1446 such that a user later selecting icon 1446 will be presented with a listing of all current food products.

In some embodiments, user product notification system 1100 may invite users to view entertainment content selected by providers for direct product placement to users who have already been established as recipients of provider products. Providers may subscribe to this service and pay for each user view. Information about how and when the user consumed the entertainment content can be delivered to the provider at provider system 1300.

In some embodiments, third party databases capable of timely user notification may be integrated into notification network 2000. For example, a retailer or distributor who does not have user identifiers may want to provide a convenience for their users. Users may upload items predisposed to health risks or safety concerns. Master data system 120 and 130 would then “flag” products that are vulnerable to food born illness or safety concerns. In some embodiments, social communities of users may identify previously unknown interactions that were not identified during pharmaceutical approval stages.

In some embodiments, a user may receive an electronic product receipt from a retailer or distributor at a mobile device in accordance with an anonymized user identifier such as a mobile subscriber identity. This electronic product receipt may subsequently be processed by the mobile device as part of the client notification system and transmitted to the server notification system for recording of product identifiers received by the user as of the purchase reflected on the electronic receipt.

In some embodiments, a provider may receive an electronic product receipt from a retailer or distributor in accordance with an anonymized user identifier such as a mobile subscriber identity. This electronic product receipt may subsequently be processed by the provider and used to determine which users, if any, are best suited to receive a direct sales invitation or other notification.

Embodiments of the present disclosure are susceptible to being used for various purposes, including, though not limited to, enabling users to receive notifications regarding matters other than product updates and information.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

1. A computer-implemented method for product notification, comprising:
transmitting, from a user mobile device, a mobile subscriber identity to register a user for a product notification service without transmitting the name of the user;
sending a product provider identifier from the user mobile device;
receiving, by the user mobile device, a notification pertaining to products associated with the product provider identifier in accordance with the product notification service; and
inviting, by the user mobile device, one or more contacts to register for the notification service by, in part, selecting the one or more contacts from a contact list recorded in the user mobile device.

2. The computer-implemented method as set forth in claim 1, further comprising transmitting a product identifier from the user mobile device.

3. The computer-implemented method as set forth in claim 1, wherein the notification includes an invitation to view a rebate, an incentive, a discount or a digital coupon.

4. The computer-implemented method as set forth in claim 1, wherein receiving the notification further comprises actively alerting the user, with the user mobile device, about a travel hazard that was present on a mode of transportation associated with mobile subscriber identity without requiring further input from the user.

5. The computer-implemented method as set forth in claim 1, wherein receiving the notification further comprises actively alerting the user about a product recall with the user mobile device without requiring further input from the user.

6. The computer-implemented method as set forth in claim 1, further comprising issuing a “notification reviewed” confirmation from the user mobile device when the user engages with the product notification.

7. (canceled)

8. A computer program product for product notification, the computer program product residing on a non-transitory computer-readable storage medium and comprising instructions which, when executed by a processor, cause a computer to:
transmit a mobile subscriber identity to register a user for a product notification service without transmitting the name of the user;
send a product provider identifier;
receive a product notification pertaining to products associated with the product provider identifier in accordance with the product notification service; and
actively alert the user about a contagion that was present on a mode of transportation associated with mobile subscriber identity without requiring input from the user.

9. The computer program product as set forth in claim 8, wherein the instructions further cause the computer to transmit a product identifier.

10. The computer program product as set forth in claim 8, wherein the product notification includes an invitation to view a rebate, an incentive, a discount or a digital coupon.

11. (canceled)

12. The computer program product as set forth in claim 8, wherein the instructions further cause the computer to actively alert the user about a product recall without requiring input from the user.

13. The computer program product as set forth in claim 8, further comprising issuing a “notification reviewed” confirmation when the user engages with the product notification.

14. A system for engaging product users, comprising:
a mobile device including a processor and a memory;
an application loaded on the memory;
the application further comprising:
a transmitter configured to send a mobile subscriber identity associated with a user from the mobile device to anonymously register the user for a notification service and to send an identifier of one or more providers of products received by the user;
a messenger arranged to receive a notification pertaining to products associated with the identifier of the one or more providers; and
an alarm configured to, without requiring input from the user, actively alert the user about a contagion that was present on a mode of transportation associated with mobile subscriber identity.

15. The system as set forth in claim 14, wherein the application further comprises a menu arranged to enable selection of one or more identifiers of the one or more products received by the user.

16. The system as set forth in claim 14, wherein the messenger is arranged to invite the user to view at least one of a rebate, an incentive, a discount and a digital coupon.

17. (canceled)

18. (canceled)

19. The system as set forth in claim 14, wherein the alarm is further configured to, without requiring input from the user, actively alert the user about a product recall.

20. The system as set forth in claim 19, wherein the messenger is further configured to issue a “message reviewed” confirmation when the user engages with the message.

21. The computer program product as set forth in claim 8, wherein the instructions further cause the computer to select one or more contacts from a contact list recorded in the user mobile device and to invite, with the user mobile device, the one or more contacts to register for the notification service.

22. The system as set forth in claim 14, wherein the application further comprises a networking module configured to receive a user selection of one or more contacts from a contact list recorded in the user mobile device and to invite, from the user mobile device, the one or more contacts to register for the notification service.
